(19) United States
(12) Patent Application Publication
(10) Pub. No.: US 2015/0122922 A1
(43) Pub. Date: May 7, 2015

(54) FOOD WASTE DISPOSER

(71) Applicant: Johnson Electric S.A., Murten (CH)

(72) Inventors: John HAMMAR, Newtown, CT (US); King Ho LAI, Hong Kong (CN); Gary M. MARCY, Rochester, NY (US); Kwong Yip POON, Hong Kong (CN); Douglas Stephen WALZ, Shelton, CT (US); Wai Chi Jacky CHAN, Hong Kong (CN); Min LI, Shenzhen (CN)

(21) Appl. No.: 14/533,914

(22) Filed: Nov. 5, 2014

Related U.S. Application Data
(60) Provisional application No. 61/900,048, filed on Nov. 5, 2013.

(51) Int. Cl. E03C 1/266; B02C 18/00

(52) U.S. Cl. CPC E03C 1/2665; B02C 18/0092
USPC 241/46.016; 241/46.013

(57) ABSTRACT

A food waste disposer includes a chamber housing, a grinder mechanism, an electric motor and a transmission device. The chamber housing defines a grinding chamber having an inlet and an outlet. The grinder mechanism is disposed within the grinding chamber and has a driven shaft and a rotating member coupled to the driven shaft. The electric motor is disposed at one side of the chamber housing and has an output shaft. The transmission device is coupled between the output shaft of the electric motor and the driven shaft of the grinder mechanism.

### CROSS REFERENCE TO RELATED APPLICATIONS

This non-provisional patent application claims priority under 35 U.S.C. §119(e) from provisional Patent Application No. 61/900,048 filed in USA on Nov. 5, 2013.

### FIELD OF THE INVENTION

This invention generally relates to a food waste disposer with low profile.

### BACKGROUND OF THE INVENTION

Food waste disposers are used to reduce food scraps to small particles that can safely pass through the plumbing and sewage system. A food waste disposer typically includes a grinder and an electric motor. The grinder includes stationary shredder ring and a rotating grinding disc driven by the motor are accommodated in a grinder chamber. The food waste is masticated by being caught between teeth on the stationary shredder ring. Pushers attached to the grinding disc help to pulverize the waste and move it to the teeth of the shredder ring.

Food waste disposers, especially those designed for domestic use, are generally installed under kitchen sinks where they are directly attached to the drains of the sinks Traditionally, the motor and other electrical components of a food waste disposer are located below the grinder chamber. The shaft of the motor is coaxial with the grinding disc and extends inside the grinder chamber to rotate the grinding disc. A seal is arranged on the shaft of the motor to prevent water in the grinder chamber from entering into the motor. Such a food waste disposer, as the motor is in line with the grinder chamber, has a relatively high profile and occupies more storage area in the cabinet under sink. Besides, if the seal loses its effectiveness, liquid leakage will happen, thereby endangering the operation of the motor and also generating safety problem.

Therefore, there is a desire for a food waste disposer with low profile, high reliability and safety performance.

### SUMMARY OF THE INVENTION

Accordingly, in one aspect thereof, the present invention provides a food waste disposer includes a chamber housing, a grinder mechanism, an electric motor and a transmission device. The chamber housing defines a grinding chamber having an inlet and an outlet. The grinder mechanism is disposed within the grinding chamber and has a driven shaft and a rotating member coupled to the driven shaft. The electric motor is disposed at one side of the chamber housing and has an output shaft. The transmission device is coupled between the output shaft of the electric motor and the driven shaft of the grinder mechanism.

Preferably, the output shaft of the electric motor is parallel to the driven shaft of the grinder mechanism.

Preferably, the transmission device includes a speed reduction transmission.

According to a preferred embodiment, the food waste disposer further includes a mounting bracket made of dielectric material wherein the electric motor is attached to the chamber housing via the mounting bracket.

According to another preferred embodiment, the food waste disposer further includes a mounting bracket and a spacer made of dielectric material and disposed between the mounting bracket and the chamber housing or between the mounting bracket and the electric motor.

Preferably, the spacer is made of an elastic material.

Preferably, the transmission device includes a driving pulley mechanically coupled to the output shaft of the electric motor, a driven pulley mechanically coupled to the driven shaft of the grinder mechanism and a belt looped over the driving and driven pulleys.

Preferably, the belt is made of a dielectric material.

Preferably, the food waste disposer further includes a bearing held by a bearing support, the driven shaft of the grinder mechanism being rotatably supported by the bearing, the driven pulley being disposed between the chamber housing and the bearing support.

Preferably, at least one of the driving pulley and the driven pulley has an annular flange extending from one axial end away from the chamber housing.

Preferably, the belt has a trapezoidal cross-section with the width of the radially outer surface greater than the width of the radially inner surface and each of the driving and driven pulleys has an annular groove in the outer circumferential surface to receive the belt.

Optionally, the transmission device includes a gear train at least having a first stage gear mounted on the output shaft of the electric motor and a last stage gear mounted on the driven shaft of the grinder mechanism.

Preferably, at least one gear of the gear train is made of dielectric material.

Preferably, the electric motor is a brushed direct current motor.

Preferably, the electric motor and the chamber housing are disposed at the same side of the transmission device.

Preferably, the transmission device is at least partly made of dielectric material.

Optionally, the transmission device further comprises a tension roller pressing the belt to obtain belt tension.

Optionally, the grinding chamber further has a second inlet adapted to be connected to an overflow hole of a sink.

In the embodiments of the present invention, as the motor is disposed at one side of the grinder chamber, the height of the food waste disposer is reduced, which makes more usable storage area in the cabinets under sinks and water in the grinder chamber will not leak into the motor even if the seal of the grinder chamber fails. Further, as the grinder is electrically insulated from the motor, high reliability and safety performance can be achieved.

### BRIEF DESCRIPTION OF THE DRAWINGS

Various embodiments of the invention are described, by way of example only, with reference to the drawings, in which identical or related structures, elements, or parts may be labeled with the same reference numerals throughout the figures. Dimensions of components and features shown in the figures are generally chosen for convenience and clarity of presentation and are not necessarily shown to scale.

FIG. 1 illustrates a food waste disposer in accordance with an embodiment of the present invention;

FIG. 2 illustrates a sectional view of a grinder being a part of the food waste disposer in FIG. 1;

FIG. 3 illustrates an upside down view of the food waste disposer in FIG. 1 with a lower housing part removed;

FIG. 4 illustrates a sectional view of a belt and a pulley being a part of a food waste disposer in FIG. 1;

FIG. 5 illustrates a sectional view of a belt and a pulley being a part of a food waste disposer in accordance with another embodiment of the present invention;

FIG. 6 illustrates a planar view of a mounting bracket with a spacer being a part of a food waste disposer in accordance with another embodiment of the present invention;

FIG. 7 illustrates a gear train being a part of a food waste disposer in accordance with another embodiment of the present invention; and

FIG. 8 illustrates a belt transmission device in accordance with another embodiment of the present invention.

### DETAILED DESCRIPTION OF THE VARIOUS EMBODIMENTS

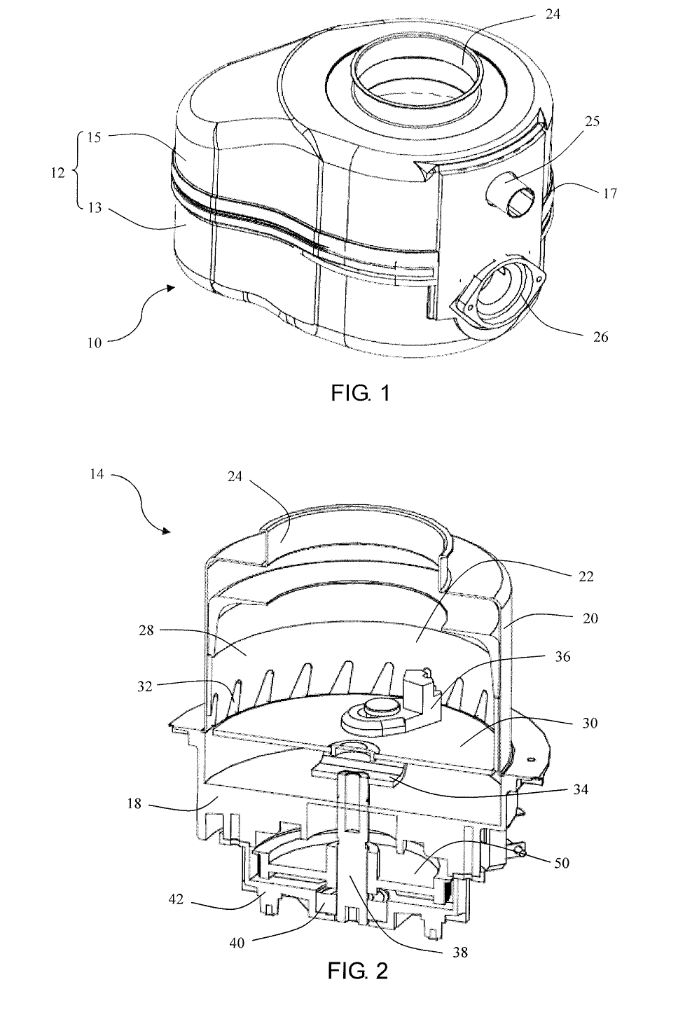

Referring to FIGS. 1 to 3, a food waste disposer 10 in accordance with an embodiment of the present invention includes a housing 12, and a grinder 14 and an electric motor 16 disposed in the housing 12. The housing 12 has a lower housing part 13 and an upper housing part 15 assembled together via a connecting ring 17.

The grinder 14 has a base 18 fixed to the housing 12 and a cover 20 seated on the base 18. The base 18 and the cover 20 form a chamber housing which defines a grinding chamber 22 with an inlet 24 axially extending through the upper wall of the upper housing part 15 and an outlet 26 radially extending through the side wall of the housing 12. The inlet 24 is adapted to be fixed to the drain of a sink (not shown) for the entrance of water and waste matter and the outlet 26 is connected, in use, to a drain pipe (not shown) for the removal of water and shredded waste matter. A second inlet 25 radially extends through the side wall of the housing 12 and is adapted to be connected to an overflow hole of the sink so as to allow water discharging from the overflow hole to enter the grinder chamber 22. A grinding mechanism is located within the grinding chamber 22 and includes a shredder ring 28 and a rotating grinding disc 30 in this embodiment. Preferably, the base 18, the shredder ring 28 and the grinding disc 30 are made of a hard material such as steel to provide sufficient mechanical strength.

The shredder ring 28 is fixed to the inner surface of the cover 20. A plurality of slanted slots 32 extend upwardly from the lower edge of the shredder ring 28 forming cutting teeth. The grinder disc 30 is mounted on a supporting bracket 34 which is fixed on one end of a driven shaft 38. Pushers 36 are attached on the grinding disc 30 close to the periphery of the grinding disc 30 to help pushing the waste matter to be shredded to the slots 32 in the shredder ring 28. The other end of the driven shaft 38 is rotatably supported by a bearing 40 held by a bearing support 42 disposed between the base 18 of the grinder 14 and the bottom wall of the lower housing part 13.

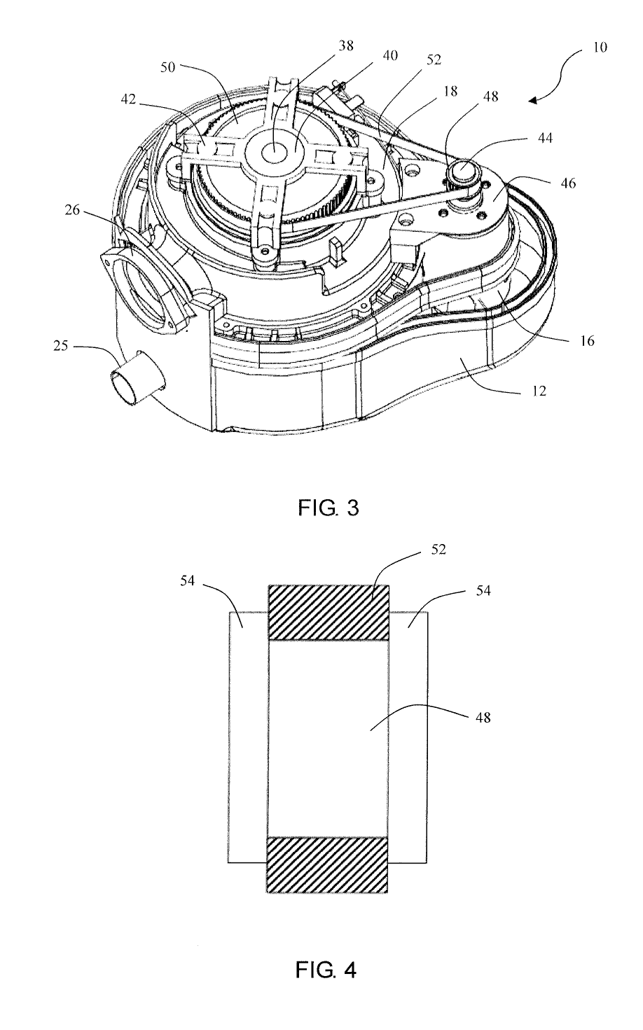

The electric motor 16 is preferably a brushed direct current motor and disposed at one side of the grinder 14 with an output shaft 44 of the motor 16 parallel to the driven shaft 38. It should be understood that other types of motors can also be used. The motor 16 is fixed to the base 18 of the grinder 14 via a mounting bracket 46. The power of the motor 16 is transferred from the output shaft 44 to the driven shaft 38 via a transmission device. In accordance with an embodiment illustrated in FIG. 3, which shows food waste disposer 10 in an upside down orientation from preferred mounting position for easy illustration, the transmission device includes a driving pulley 48 on the output shaft 44, a driven pulley 50 on the driven shaft 38, and a belt 52 looped over the driving and driven pulleys 48 and 50. The driving pulley 48 is located between the mounting bracket 46 and the bottom wall of the lower housing part 13. The driven pulley 50 is between the base 18 of the grinder 14 and the bearing support 42. The driving pulley 48 has an outer diameter smaller than the driven pulley 50, so that the rotation of the output shaft 44 is transferred to the driven shaft 38 with the speed reduced and the torque increased.

In accordance with an embodiment of the present invention, the pulleys 48 and 50 are made of plastic to reduce the cost. The belt 52 is made of dielectric material such as rubber. The mounting bracket 46 is made of a dielectric material such as plastic. By this configuration, the grinder 14 and the electric motor 16 are electrically insulated from each other and higher reliability and safety performance are achieved even if liquid in the grinder 14 is leaked out.

In accordance with a preferred embodiment, as shown in FIG. 4, the driving pulley 48 has annular flanges 54 radially extending from two axial ends thereof and the belt 52 is axially positioned between the annular flanges 54 so that it can not slip off.

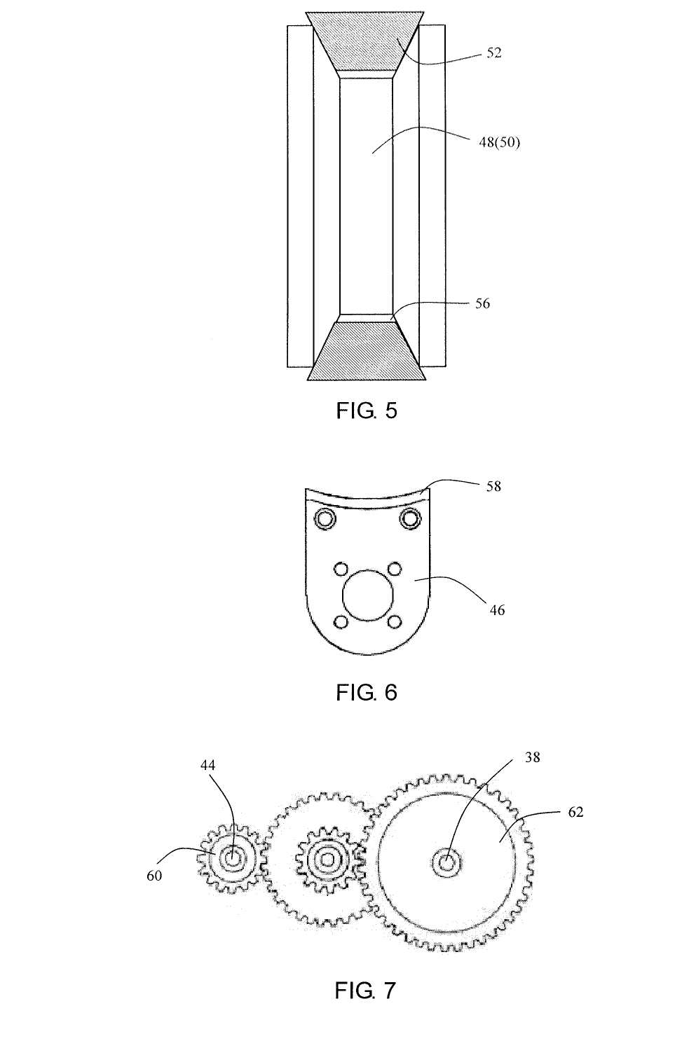

According to another preferred embodiment of the present invention, as shown in FIG. 5, the belt 52 is a truncated V-belt having a trapezoidal cross-section with the width of the radially outer surface greater than the width of the radially inner surface. Each of the driving and driven pulleys 48 and 50 has an annular groove 56 in the outer circumferential surface to receive the truncated V-belt 52. Thus, the belt 52 will not slip off from the pulleys 48 and 50.

According to another embodiment of the present invention, as shown in FIG. 6, at least one spacer 58 is disposed between the mounting bracket 46 and the base 18 of the grinder 14. The spacer 58 is preferably made of elastic dielectric material such as rubber to electrically insulate the motor 16 from the base 18 even if the mounting bracket 46 is made of conductive material. The spacer 58 can also isolate the grinder 14 from the vibration of the motor 16.

Although the invention is described with reference to one or more preferred embodiments, it should be appreciated by those skilled in the art that various modifications are possible. Therefore, the scope of the invention is to be determined by reference to the claims that follow.

In the description and claims of the present application, each of the verbs “comprise”, “include”, “contain” and “have”, and variations thereof, are used in an inclusive sense, to specify the presence of the stated item but not to exclude the presence of additional items.

For example, according to another embodiment of the present invention, as shown in FIG. 7, the transmission device includes a gear train having at least a first stage gear 60 mounted on the output shaft 44 of the motor 16 and a last stage gear 62 mounted on the driven shaft 38. Preferably, at least one gear of the gear train is made of dielectric material such as plastic to electrically insulate the motor 16 from the grinder 14.

For another example, the spacer 58 can be alternately disposed between the mounting bracket 46 and the motor 16.

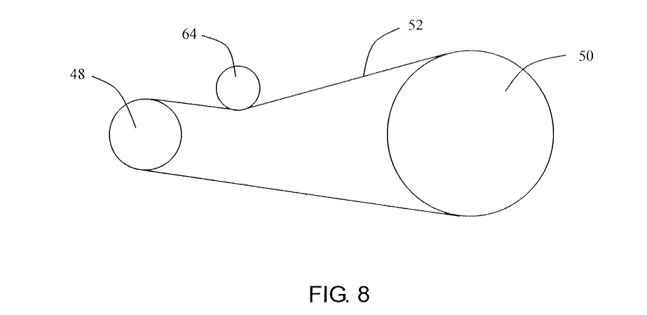

For another example, as shown in FIG. 8, the belt transmission device further comprises a tension roller 64 pressing the belt 52 to obtain belt tension.

1. A food waste disposer, comprising:
a chamber housing defining a grinding chamber having an inlet and an outlet;
a grinder mechanism disposed within the grinding chamber and having a driven shaft and a rotating member coupled to the driven shaft;
an electric motor disposed at one side of the chamber housing and having an output shaft; and
a transmission device coupled between the output shaft of the electric motor and the driven shaft of the grinder mechanism.

2. The food waste disposer of claim 1, wherein the output shaft of the electric motor is parallel to the driven shaft of the grinder mechanism.

3. The food waste disposer of claim 1, wherein the transmission device includes a speed reduction transmission.

4. The food waste disposer of claim 1, further comprising a mounting bracket made of dielectric material, wherein the electric motor is attached to the chamber housing via the mounting bracket.

5. The food waste disposer of claim 1, further comprising a mounting bracket and a spacer made of a dielectric material and disposed between the mounting bracket and the chamber housing or between the mounting bracket and the electric motor.

6. The food waste disposer of claim 5, wherein the spacer is made of an elastic material.

7. The food waste disposer of claim 1, wherein the transmission device includes
a driving pulley mechanically coupled to the output shaft of the electric motor;
a driven pulley mechanically coupled to the driven shaft of the grinder mechanism; and
a belt looped over the driving and driven pulleys.

8. The food waste disposer of claim 7, wherein the belt is made of a dielectric material.

9. The food waste disposer of claim 7, further comprising a bearing held by a bearing support, the driven shaft of the grinder mechanism being rotatably supported by the bearing, the driven pulley being disposed between the chamber housing and the bearing support.

10. The food waste disposer of claim 7, wherein at least one of the driving pulley and the driven pulley has an annular flange extending from one axial end away from the chamber housing.

11. The food waste disposer of claim 7, wherein the belt has a trapezoidal cross-section with the width of the radially outer surface greater than the width of the radially inner surface and each of the driving and driven pulleys has an annular groove in the outer circumferential surface to receive the belt.

12. The food waste disposer of claim 1, wherein the transmission device includes a gear train at least having a first stage gear mounted on the output shaft of the electric motor and a last stage gear mounted on the driven shaft of the grinder mechanism.

13. The food waste disposer of claim 12, wherein at least one gear of the gear train is made of dielectric material.

14. The food waste disposer of claim 1, wherein the electric motor is a brushed direct current motor.

15. The food waste disposer of claim 1, wherein the electric motor and the chamber housing are disposed at the same side of the transmission device.

16. The food waste disposer of claim 1, wherein the transmission device is at least partly made of dielectric material.

17. The food waste disposer of claim 7, wherein the transmission device further comprises a tension roller pressing the belt to obtain belt tension.

18. The food waste disposer of claim 1, the grinding chamber further having a second inlet adapted to be connected to an overflow hole of a sink.
